(19) United States
(12) Patent Application Publication
(10) Pub. No.: US 2024/0067850 A1
(43) Pub. Date: Feb. 29, 2024

(54) DEBONDABLE STRUCTURE BASED ON A SOLVENT-BORNE PRESSURE SENSITIVE ADHESIVE (PSA)

(71) Applicant: Henkel AG & Co. KGaA, Düsseldorf (DE)

(72) Inventors: Tobias Roschek, Solingen (DE); Carla Negele, Neuss (DE); Sebastian Kotthoff, Porta Westfalica (DE); Frank Goethel, Chemnitz (DE)

(21) Appl. No.: 18/486,309

(22) Filed: Oct. 13, 2023

Related U.S. Application Data
(63) Continuation of application No. PCT/EP2022/056602, filed on Mar. 15, 2022.

(30) Foreign Application Priority Data
Apr. 14, 2021 (EP) 21168287.7

(51) Int. Cl. C09J 133/08; B32B 7/12; B32B 15/04; B32B 15/20; B32B 43/00; C09J 9/02; C09J 11/06

(52) U.S. Cl. CPC C09J 133/08; B32B 7/12; B32B 15/043; B32B 15/20; B32B 43/006; C09J 9/02; C09J 11/06; B32B 2255/06; B32B 2255/26; B32B 2307/202; B32B 2307/748; C09J 2301/314; C09J 2301/408; C09J 2301/502; C09J 2400/163; C09J 2433/00

(57) ABSTRACT

The present application is directed to a bonded structure comprising: a first substrate having an electrically conductive surface; and, a second substrate having an electrically conductive surface; wherein an electrochemically-debondable pressure sensitive adhesive film is disposed between the electrically conductive surfaces of the first and second substrates, said adhesive film being obtained by drying of a solvent-borne composition comprising, based on the weight of the composition: from 5 to 80 wt. % of a) at least one (meth)acrylate copolymer; from 0.1 to 30 wt. % of b) non-polymerizable electrolyte; and, from 10 to 90 wt. % of c) solvent.

### FIELD OF THE INVENTION

The present invention is directed to an adhesive composition which can be debonded from particular substrates to which it is applied. The present invention is further directed to a structure which comprises first and second substrates which are adhered with a solvent-borne and electrochemically debondable pressure sensitive adhesive (PSA) composition.

### BACKGROUND TO THE INVENTION

Adhesive bonds and polymeric coatings are commonly used in the assembly and finishing of manufactured goods. They are used in place of mechanical fasteners, such as screws, bolts and rivets, to provide bonds with reduced machining costs and greater adaptability in the manufacturing process. Adhesive bonds distribute stresses evenly, reduce the possibility of fatigue and seal the joints from corrosive species.

Whilst adhesive bonds thus offer many advantages over mechanical fasteners, it tends to be difficult to disassemble adhesively bonded objects where this is required in practical applications. The removal of the adhesive through mechanical processes—such as by sand blasting or by wire brushing—is often precluded, in part because the adhesive is disposed between substrates and is thus either inaccessible or difficult to abrade without corrupting the substrate surfaces. Disassembly through the application of chemicals and/or high temperature—such as disclosed in U.S. Pat. No. 4,171,240 (Wong) and U.S. Pat. No. 4,729,797 (Linde et al.)—might be effective but can be time consuming and complex to perform: moreover, the aggressive chemicals and/or harsh conditions required can damage the substrates being separated, rendering them unsuitable for subsequent applications.

Noting these problems, certain authors have sought to develop electrochemically debondable adhesive compositions, wherein the passage of an electrical current through the dried or cured compositions acts to disrupt the bonding at the interface of the adhesive and the substrate.

WO2007/142600 (Stora Enso AB) describes an electrochemically weakened adhesive composition which provides an adhesive bond to an electrically conducting surface and sufficient ion conductive properties to enable a weakening of said adhesive bond at the application of a voltage across the adhesive composition, wherein said composition comprises at least one ionic compound in an effective amount to give said ion conductive properties and wherein said ionic compound has a melting point of no more than 120° C.

WO2013/135677 (Henkel AG & Co. KGaA) describes a hot melt adhesive containing: from 20 to 90 wt % of at least one polyamide having a molecular weight (Mw) from 10,000 to 250,000 g/mol; from 1 to 25 wt % of at least one organic or inorganic salt; and, from 0 to 60 wt % of further additives, wherein the adhesive has a softening point from 100° C. to 220° C.

US 2007/0269659 (Gilbert) describes an adhesive composition disbondable at two interfaces, the composition: (i) comprising a polymer and an electrolyte; (ii) facilitating joinder of two surfaces; and, (iii) in response to a voltage applied across both surfaces so as to form an anodic interface and a cathodic interface, disbonding from both the anodic and cathodic surfaces.

US 2008/0196828 (Gilbert) describes a hot-melt adhesive composition comprising: a thermoplastic component; and, an electrolyte, wherein the electrolyte provides sufficient ionic conductivity to the composition to enable a faradaic reaction at a bond formed between the composition and an electrically conductive surface and to allow the composition to disbond from the surface.

U.S. Pat. No. 7,465,492 (Gilbert) describes an electrochemically disbondable composition comprising: a matrix functionality comprising a monomer selected from the group consisting of acrylics, methacrylics and combinations thereof; a free radical initiator; and, an electrolyte, wherein the electrolyte provides sufficient ionic conductivity to said composition to support a faradaic reaction at a bond formed between the composition and an electrically conductive surface and thus allows the composition to disbond from the surface. In this citation, the electrolyte comprises a salt which is capable of being solvated into the composition and which is a member of the group consisting of the ammonium (NH4+), alkali metal, alkali earth or rare earth salts of perchlorate, tetrafluoroborate, hexafluorophosphate, triflate and triflimide anions.

EP 3363875 A (Nitto Denko Corporation) provides an electrically peelable adhesive composition that forms an adhesive layer which has high adhesion and can be easily peeled off upon application of a voltage for a short time. The electrically peelable adhesive composition of the invention includes a polymer and from 0.5 to 30 wt. %, based on the weight of the polymer, of an ionic liquid, wherein the anion of the ionic liquid is a bis(fluorosulfonyl)imide anion.

WO2017/133864 (Henkel AG & Co. KGaA) describes a method for reversibly bonding a first and a second substrate, wherein at least the first substrate is an electrically non-conductive substrate, the method comprising: a) coating the surface of the electrically non-conductive substrate(s) with a conductive ink; b) applying an electrically debondable hot melt adhesive composition to the conductive ink-coated surface of the first substrate and/or the second substrate; c) contacting the first and the second substrates such that the electrically debondable hot melt adhesive composition is interposed between the two substrates; d) allowing formation of an adhesive bond between the two substrates to provide bonded substrates; and, e) applying a voltage to the bonded substrates whereby adhesion at an interface between the electrically debondable hot melt adhesive composition and a substrate surface is substantially weakened.

There remains a need in the art to provide pressure sensitive adhesive compositions which can be conveniently applied to the surfaces of substrates to be bonded, which upon drying, solidification and the application of appropriate pressure, can provide an effective bond within composite structures containing said substrates but which can be effectively de-bonded from those substrates by the facile application of an electrical potential across the solidified adhesive.

### BRIEF DESCRIPTION OF THE DRAWINGS

FIG. 1a depicts a bonded structure in accordance with a first embodiment of the present invention.

FIG. 1b depicts a bonded structure in accordance with a second embodiment of the present invention.

FIG. 2a depicts an example of initial debonding of the structure of the first embodiment upon passage of a current across that structure.

FIG. 2b depicts an example of initial debonding of the structure of the second embodiment upon passage of a current across that structure.

### STATEMENT OF THE INVENTION

In accordance with a first aspect of the present disclosure, there is provided a bonded structure comprising
a first substrate having an electrically conductive surface; and,
a second substrate having an electrically conductive surface;
wherein an electrochemically debondable, pressure sensitive adhesive film is disposed between the electrically conductive surfaces of the first and second substrates, said adhesive film being obtained by drying of a solvent-borne composition comprising, based on the weight of the composition:
   i. from 5 to 80 wt. % of a) at least one (meth)acrylate copolymer;
   ii. from 0.1 to 30 wt. % of b) non-polymerizable electrolyte; and,
   iii. from 10 to 90 wt. % of c) solvent.

In accordance with an important embodiment, said solvent-borne composition comprises, based on the weight of the composition:
a. from 15 to 75 wt. %, preferably from 30 to 70 wt. % of a) said at least one (meth)acrylate copolymer;
b. from 1 to 20 wt. %, preferably from 1 to 15 wt. % of b) said non-polymerizable electrolyte;
c. from 20 to 80 wt. %, preferably from 30 to 70 wt. % of c) solvent; and,
d. from 0 to 10 wt. %, preferably from 0 to 5 wt. % of d) solubilizer.

It is preferred that a) said at least one (meth)acrylate copolymer is characterized by at least one of: a glass transition temperature (Tg) of from −30° C. to 60° C.; and, a weight average molecular weight of from 50000 to 500000 daltons.

Independently of or additional to this statement of preference, it is preferred that said at least one (meth)acrylate copolymer has pendent hydroxyl groups in its polymer backbone. In this regard, said at least one (meth)acrylate copolymer may preferably comprise, based on the total weight of monomers:
from 35 to 95 wt. %, preferably from 50 to 90 wt. % and more preferably from 60 to 85 wt. % of a1) at least one (meth)acrylate monomer represented by Formula A1:

H₂C═CGCO₂R¹ (A1)
wherein: G is hydrogen, halogen or a C₁ alkyl group; and,
   R¹ is selected from: C₁-C₃₀ alkyl; C₂-C₃₀ heteroalkyl; C₃-C₃₀ cycloalkyl; C₂-C₈ heterocycloalkyl; C₂-C₂₀ alkenyl; C₂-C₁₂ alkynyl; C₆-C₁₈ aryl; C₁-C₉ heteroaryl; C₇-C₁₈ alkaryl; and, C₇-C₁₈ aralkyl;
from 5 to 65 wt. %, preferably from 10 to 50 wt. % and more preferably from 15 to 40 wt. % of a2) at least one (meth)acrylate monomer represented by Formula A2:

H₂C═CQCO₂R₂ (A2)
wherein: Q may be hydrogen, halogen or a C₁ alkyl group; and,
   R₂ is selected from: C₁-C₁₈ hydroxyalkyl; and, C₃-C₃₀ hydroxycycloalkyl.

Good results have been obtained where b) said non-polymerizable electrolyte is selected from the group consisting of 1-ethyl-3-methylimidazolium chloride, 1-ethyl-3-methyl-1H-imidazol-3-um methanesulfonate, 1-ethyl-3-methylimidazolium trifluoromethanesulfonate, 1-ethyl-3-methylimidazolium tetrafluoroborate, 1-ethyl-3-methylimidazolium thiocyanate and mixtures thereof.

Within the bonded structure, the first and second substrates may be provided as, respectively, first and second substrate layers. Independently of or additional to this preference, said first and second substrates may be independently selected from the group consisting of: metallic films; metallic meshes or grids; deposited metal particles; conducting oxides; plastic or resinous substrates which are rendered conductive by virtue of conductive elements disposed therein or thereon; paper substrates, such as kraft paper, wood free paper, paperboard, glassine paper and parchment paper, which are rendered conductive by virtue of conductive elements disposed therein or thereon; and, woven or non-woven fabrics which are rendered conductive by virtue of conductive elements disposed therein or thereon. Independently of or additional to this statement of preference, it is preferred that the electrically conductive surfaces of the first and second substrates are characterized by a surface energy of at least 50 dynes/cm, preferably at least 100 dynes/cm, more preferably at least 250 dynes/cm, as measured according to the method of ASTM D2578.

In accordance with a second aspect of the present invention, there is provided a method of debonding said bonded structure as defined hereinabove and in the appended claims, the method comprising the steps of:
i) applying a voltage across both surfaces to form an anodic interface and a cathodic interface; and,
ii) debonding the surfaces.

Step i) of this method is preferably characterized by at least one of:
a) an applied voltage of from 0.5 to 200 V; and,
b) the voltage being applied for a duration of from 1 second to 60 minutes.

The adhesive property of the composition is disrupted by the application of an electrical potential across the bondline between that composition and the conductive surfaces. Without intention to be bound by theory, it is considered that the faradaic reactions which take place at the interface between the adhesive composition and the conductive surfaces disrupt the interaction between the adhesive and the substrate, thereby weakening the bond therebetween. That interfacial disruption may be the consequence of one or more processes, for instance chemical degradation of the debondable substrate, chemical migration, gas evolution at the interface and/or substrate embrittlement.

The present disclosure also provides for the use of a solvent-borne composition as an electrochemically debondable, pressure sensitive adhesive, said composition comprising, based on the weight of the composition:
a. from 5 to 80 wt. % of a) at least one (meth)acrylate copolymer;
b. from 0.1 to 30 wt. % of b) non-polymerizable electrolyte; and,
c. from 10 to 90 wt. % of c) solvent.

The statements of preference for the pressure adhesive composition defined above and in the appended claims apply to this aspect of the disclosure.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps.

As used herein, the term “consisting of” excludes any element, ingredient, member or method step not specified. For completeness, the term “comprising” encompasses “consisting of”.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a weight range represented as being “from 0 to x” specifically includes 0 wt. %: the ingredient defined by said range may be absent from the composition or may be present in the composition in an amount up to x wt. %.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

As used herein, room temperature is 23° C. plus or minus 2° C.

The molecular weights referred to in this specification—to describe to macromolecular, oligomeric and polymeric components of the curable compositions—can be measured with gel permeation chromatography (GPC) using polystyrene calibration standards, such as is done according to ASTM 3536.

Viscosities of the compositions described herein are, unless otherwise stipulated, measured using the Brookfield Viscometer at standard conditions of 20° C. and 50% Relative Humidity (RH). The method of calibration, the spindle type and rotation speed of the Brookfield Viscometer are chosen according to the instructions of the manufacturer as appropriate for the composition to be measured.

As used in the art, the term “pressure-sensitive adhesive” refers to adhesive compositions that have: (1) persistent tack; (2) adherence with no more than finger pressure; (3) sufficient ability to hold onto an adherend; and, (4) sufficient cohesive strength to be cleanly removable from the adherend.

As used herein the term “electrochemically debondable” means that, after curing of the pressure sensitive adhesive, the bond strength can be weakened by at least 50% upon application of an electrical potential of 30 V for a duration of 30 minutes. The pressure sensitive adhesive is applied between two aluminium foils which are bonded by said adhesive so that an electric current is running through the adhesive bond line. Bond strength is measured by peel adhesion test (180° C., 10 mm/min) according to FTM-1 in FINAT Technical Handbook 9th Edition with slight modifications, mainly the adhesive thickness being 50 μm and sample width 10 mm.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “polyfunctional”, as used herein, refers to the possession of more than one polymerizable moiety.

As used herein “solvents” are substances capable of dissolving another substance to form a uniform solution; during dissolution neither the solvent nor the dissolved substance undergoes a chemical change. Solvents may either be polar or non-polar.

The term “electrolyte” is used herein in accordance with its standard meaning in the art as a substance containing free ions which can conduct electricity by displacement of charged carrier species. The term is intended to encompass molten electrolytes, liquid electrolytes, semi-solid electrolytes and solid electrolytes wherein at least one of the cationic or anionic components of their electrolyte structure is essentially free for displacement, thus acting as charge carrier.

As used herein, the term “metallic” encompasses elemental metal, metal alloys and metal composites. As exemplary metals and metallic alloys, mention may be made of: aluminum; aluminum alloys; bronze; beryllium; beryllium alloys; chromium; chromium alloys; cobalt; cobalt alloys; copper; copper alloys; gold; iron; iron alloys; steels; magnesium; magnesium alloys; nickel; nickel alloys; lead; lead alloys; tin; tin alloys, such as tin-bismuth and tin-lead; zinc; zinc alloys; and, superalloys, such as International Nickel 100 (IN-100) or International Nickel 718 (IN-718). Representative steels include: crucible steel; carbon steel; spring steel; alloy steel; maraging steel; and, stainless steel, inclusive of austenitc stainless steel, ferritic stainless steel, duplex stainless steel, and Martensitic stainless steel.

The adhesive compositions of the present invention and the adhesives obtained therefrom possess “electrolyte functionality” in that the adhesive substrate permits the conduction of ions, either anions, cations or both. The electrolyte functionality is understood to derive from the ability of the compositions and cured adhesives to solvate ions of at least one polarity.

The term “faradaic reaction” means an electrochemical reaction in which a substrate is oxidized or reduced.

As used herein, “(meth)acryl” is a shorthand term referring to “acryl” and/or “methacryl”. Thus the term “(meth)acrylate” refers collectively to acrylate and methacrylate.

As used herein, “C1-Cn alkyl” group refers to a monovalent group that contains 1 to n carbons atoms, that is a radical of an alkane and includes straight-chain and branched organic groups. As such, a “C1-C18 alkyl” group refers to a monovalent group that contains from 1 to 18 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more halogen. Where applicable for a given moiety (R), a tolerance for one or more non-halogen substituents within an alkyl group will be noted in the specification.

The term “C1-Cn hydroxyalkyl” as used herein refers to a HO-(alkyl) group having from 1 to n carbon atoms, where the point of attachment of the substituent is through the oxygen-atom and the alkyl group is as defined above.

An “alkoxy group” refers to a monovalent group represented by—OA where A is an alkyl group: non-limiting examples thereof are a methoxy group, an ethoxy group and an iso-propyloxy group. The term “C1-C18 alkoxyalkyl” as used herein refers to an alkyl group having an alkoxy substituent as defined above and wherein the moiety (alkyl-O-alkyl) comprises in total from 1 to 18 carbon atoms: such groups include methoxymethyl (—CH2OCH3), 2-methoxyethyl (—CH2CH2OCH3) and 2-ethoxyethyl.

The term “C2-C4 alkylene” as used herein, is defined as saturated, divalent hydrocarbon radical having from 2 to 4 carbon atoms.

The term “C3-C30 cycloalkyl” is understood to mean a saturated, mono- or polycyclic hydrocarbon group having from 3 to 30 carbon atoms. In the present invention, such cycloalkyl groups may be unsubstituted or may be substituted with one or more halogen. Where applicable for a given moiety (R), a tolerance for one or more non-halogen substituents within a cycloalkyl group will be noted in the specification. Examples of cycloalkyl groups include: cyclopropyl; cyclobutyl; cyclopentyl; cyclohexyl; cycloheptyl; cyclooctyl; adamantane; and, norbornane.

The term “C3-C30 hydroxycycloalkyl” as used herein refers to a HO-(cycloalkyl) group having from 3 to 30 carbon atoms, where the point of attachment of the substituent is through the oxygen-atom and the cycloalkyl group is as defined above.

As used herein, an “C6-C18 aryl” group used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present invention, such aryl groups may be unsubstituted or may be substituted with one or more halogen. Where applicable for a given moiety (R), a tolerance for one or more non-halogen substituents within an aryl group will be noted in the specification. Exemplary aryl groups include: phenyl; (C1-C4)alkylphenyl, such as tolyl and ethylphenyl; indenyl; naphthalenyl, tetrahydronaphthyl, tetrahydroindenyl; tetrahydroanthracenyl; and, anthracenyl. And a preference for phenyl groups may be noted.

As used herein, “C2-C20 alkenyl” refers to hydrocarbyl groups having from 2 to 20 carbon atoms and at least one unit of ethylenic unsaturation. The alkenyl group can be straight chained, branched or cyclic and may optionally be substituted with one or more halogen. Where applicable for a given moiety (R), a tolerance for one or more non-halogen substituents within an alkenyl group will be noted in the specification. The term “alkenyl” also encompasses radicals having “cis” and “trans” configurations, or alternatively, “E” and “Z” configurations, as appreciated by those of ordinary skill in the art. Examples of said C2-C20 alkenyl groups include, but are not limited to: —CH═CH2; —CH═CHCH3; —CH2CH═CH2; —C(═CH2)(CH3); —CH═CHCH2CH3; —CH2CH═CHCH3; —CH2CH2CH═CH2; —CH═C(CH3)2; —CH2C(═CH2)(CH3); —C(═CH2)CH2CH3; —C(CH3)═CHCH3; —C(CH3)CH═CH2; —CH═CHCH2CH2CH3; —CH2CH═CHCH2CH3; —CH2CH2CH═CHCH3; —CH2CH2CH2CH═CH2; —C(═CH2)CH2CH2CH3; —C(CH3)═CHCH2CH3; —CH(CH3)CH═CHCH; —CH(CH3)CH2CH═CH2; —CH2CH═C(CH3)2; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “alkylaryl” refers to alkyl-substituted aryl groups and “substituted alkylaryl” refers to alkylaryl groups further bearing one or more substituents such as halo, nitro, cyano, amido, amino, sulfonyl, sulfinyl, sulfanyl, sulfoxy, urea, thiourea, sulfamoyl, sulfamide and hydroxy. Further, as used herein “aralkyl” means an alkyl group substituted with an aryl radical as defined above.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

### DETAILED DESCRIPTION OF THE INVENTION

The bonded structure of the present disclosure is obtained bringing together under pressure, first and second substrates, wherein at least one surface of the first or second substrate is provided with a film of pressure sensitive adhesive. That film is obtained from a solvent-borne pressure sensitive adhesive composition.

### a) (Meth)acrylate Copolymer

The pressure sensitive adhesive composition of the present invention comprises from 5 to 80 wt. %, based on the weight of the composition, of a) at least one (meth)acrylate copolymer. The composition might comprise from 15 to 75 wt. %, for example from 30 to 70 wt. % of a) said at least one (meth)acrylate copolymer based on the weight of the composition. It is preferred that the or each (meth)acrylate copolymer included in the composition be characterized by at least one of: a glass transition temperature (Tg) of from −30° C. to 60° C.; and, a weight average molecular weight of from 50000 to 500000 daltons, wherein the measurement of Tg is measured with Differential Scanning calorimetry (DSC).

Whilst there is no particular intention to limit the constituent monomers from which the (meth)acrylate copolymer(s) is derived, it is preferred that the or each (meth)acrylate copolymer has pendent hydroxyl groups in its polymer backbone. The or each (meth)acrylate copolymer included in the composition may preferably comprise, based on the total weight of monomers:
from 35 to 95 wt. %, preferably from 50 to 90 wt. % and more preferably from 60 to 85 wt. % of a1) at least one (meth)acrylate monomer represented by Formula A1:

H₂C═CGCO₂R₁ (A1)
wherein: G is hydrogen, halogen or a C₁ alkyl group; and,
   R¹ is selected from: C₁-C₃₀ alkyl; C₂-C₃₀ heteroalkyl; C₃-C₃₀ cycloalkyl; C₂-C₈ heterocycloalkyl; C₂-C₂₀ alkenyl; C₂-C₁₂ alkynyl; C₆-C₁₈ aryl; C₁-C₉ heteroaryl; C₇-C₁₈ alkaryl; and, C₇-C₁₈ aralkyl;
from 5 to 65 wt. %, preferably from 10 to 50 wt. % and more preferably from 15 to 40 wt. % of a2) at least one (meth)acrylate monomer represented by Formula A2:

H₂C═CQCO₂R₂ (A2)
wherein: Q may be hydrogen, halogen or a C₁ alkyl group; and,
   R₂ is is selected from: C₁-C₁₈ hydroxyalkyl; and, C₃-C₃₀ hydroxycycloalkyl.

Where the amount of the hydroxyl-functional (meth)acrylate monomer in the copolymer is above 65 wt. %, this is considered to negatively affect the adhesion properties of the composition upon application.

As regards Formula A1, it is preferred that R1 be selected from C1-C18 alkyl, C2-C18 heteroalkyl, C3-C18 cycloalkyl; C2-C8 heterocycloalkyl; C2-C8 alkenyl, and, C2-C8 alkynyl. Desirably, said monomer(s) a1) are characterized in that R1 is selected from C1-C12 alkyl and C3-C12 cycloalkyl.

Examples of (meth)acrylate monomers a1) in accordance with Formula (AI) include but are not limited to: methyl (meth)acrylate; ethyl (meth)acrylate; butyl (meth)acrylate; hexyl (meth)acrylate; 2-ethylhexyl (meth)acrylate; dodecyl (meth)acrylate; lauryl (meth)acrylate; cyclohexyl (meth)acrylate; isobornyl (meth)acrylate; ethylene glycol monomethyl ether (meth)acrylate; ethylene glycol monoethyl ether (meth)acrylate; ethylene glycol monododecyl ether (meth)acrylate; diethylene glycol monomethyl ether (meth)crylate; trifluoroethyl (meth)acrylate; and, perfluorooctyl (meth)acrylate.

As regards Formula A2, it is preferred that R2 is selected from: C1-C12 hydroxylalkyl; and, C3-C18 hydroxycycloalkyl. Desirably, said monomer(s) a2) are characterized in that R2 is selected from C1-C8 hydroxyalkyl and C3-C12 hydroxycycloalkyl.

Examples of (meth)acrylate monomers a2) in accordance with Formula (A2) include but are not limited to: 2-hydroxyethyl (meth)acrylate (HEMA); 2-hydroxypropyl (meth)acrylate; 3-hydroxypropyl (meth)acrylate; 3-hydroxybutyl (meth)acrylate; 4-hydroxybutyl(meth)acrylate; cyclohexanedimethanol mono-(meth)acrylate; 1,4-bis(hydroxymethyl)cyclohexane mono-(meth)acrylate; 1,4-dihydrocyclohexane mono-(meth)acrylate; and, octahydro-4,7-methano-1H-indene-dimethanol mono-(meth)acrylate.

In addition to monomers a1) and a2) as defined above, the (meth)acrylate copolymer may comprise:
a. from 0 to 60 wt. %, for instance from 0 to 40 wt. % or 0 to 25 wt. % of a3) at least one (meth)acrylate-functionalized oligomer; and,
b. from 0 to 60 wt. %, for instance from 0 to 40 wt. % or 0 to 25 wt. % of ethylenically unsaturated non-ionic monomers not conforming to the definitions of a1) to a3).

Said (meth)acrylate-functionalized oligomers may have one or more acrylate and/or methacrylate groups attached to the oligomeric backbone, which (meth)acrylate functional groups may be in a terminal position on the oligomer and/or may be distributed along the oligomeric backbone. It is preferred that said at least one (meth)acrylate functionalized oligomers: i) have two or more (meth)acrylate functional groups per molecule; and/or, ii) have a weight average molecular weight (Mw) of from 300 to 1000 daltons.

Examples of such oligomers, which may be used alone or in combination, include but are not limited to: (meth)acrylate-functionalized urethane oligomers such as (meth)acrylate-functionalized polyester urethanes and (meth)acrylate-functionalized polyether urethanes; (meth)acrylate-functionalized polyepoxide resins; (meth)acrylate-functionalized polybutadienes; (meth)acrylic polyol (meth)acrylates; polyester (meth)acrylate oligomers; polyamide (meth)acrylate oligomers; and, polyether (meth)acrylate oligomers. Such (meth)acrylate-functionalized oligomers and their methods of preparation are disclosed in inter alia: U.S. Pat. Nos. 4,574,138; 4,439,600; 4,380,613; 4,309,526; 4,295,909; 4,018,851; 3,676,398; 3,770,602; 4,072,529; 4,511,732; 3,700,643; 4,133,723; 4,188,455; 4,206,025; 5,002,976. Of the aforementioned polyether (meth)acrylates oligomers, specific examples include but are not limited to: PEG 200 DMA (n≈4); PEG 400 DMA (n≈9); PEG 600 DMA (n≈14); and, PEG 800 DMA (n≈19), in which the assigned number (e.g., 400) represents the weight average molecular weight of the glycol portion of the molecule.

As noted above, the copolymers may include ethylenically unsaturated non-ionic monomers not conforming to the given definitions of a1) to a3). Without intention to limit the present invention, such further ethylenically unsaturated non-ionic monomers may include: α,β-monoethylenically unsaturated monocarboxylic acids such as methacrylic acid, acrylic acid and crotonic acid; α,β-monoethylenically unsaturated dicarboxylic acids such as itaconic acid, maleic acid and fumaric acid; C1-C6 alkyl half-esters of α,β-monoethylenically unsaturated dicarboxylic acids; α,β-monoethylenically unsaturated tricarboxylic acids such as aconitic acid; C1-C6 alkyl esters of α,β-monoethylenically unsaturated tricarboxylic acids bearing at least one free carboxylic acid group; vinylphosphonic acid; ethylenically unsaturated sulfonic acids, such as vinylsulfonic acid, styrenesulfonic acid and acrylamidomethylpropanesulfonic acid; vinyl esters, such as vinyl acetate, vinyl propionate and monomers of the VEOVA™ series available from Shell Chemical Company; vinyl and vinylidene halides; vinyl ethers such as vinyl ethyl ether; vinyl ketones including alkyl vinyl ketones, cycloalkyl vinyl ketones, aryl vinyl ketones, arylalkyl vinyl ketones, and arylcycloalkyl vinyl ketones; aromatic or heterocyclic aliphatic vinyl compounds; poly(meth)acrylates of alkane polyols, such as ethylene glycol di(meth)acrylate, propylene glycol di(meth)acrylate, butylene glycol di(meth)acrylate, neopentyl glycol di(meth)acrylate, hexylene glycol di(meth)acrylate, trimethylolpropane tri(meth)acrylate, glycerin tri(meth)acrylate, and pentaerythritol tetra(meth)acrylate; poly(meth)acrylates of oxyalkane polyols such as diethylene glycol di(meth)acrylate, dipropylene glycol di(meth)acrylate, triethylene glycol di(meth)acrylate, tetraethylene glycol di(meth)acrylate, dibutylene glycol di(meth)acrylate, di(pentamethylene glycol)dimethacrylate; polyethylene glycol di(meth)acrylates; and, bisphenol-A di(meth)acrylates, such as ethoxylated bisphenol-A (meth)acrylate (“EBIPMA”).

Representative examples of other ethylenically unsaturated polymerizable non-ionic monomers include, without limitation: ethylene glycol dimethacrylate (EGDMA); fumaric, maleic, and itaconic anhydrides, monoesters and diesters with C1-C4 alcohols such as methanol, ethanol, propanol, isopropanol, butanol, isobutanol, and tert-butanol. Representative examples of vinyl monomers include, without limitation, such compounds as: vinyl acetate; vinyl propionate; vinyl ethers, such as vinyl ethyl ether; and, vinyl ethyl ketone. Representative examples of aromatic or heterocyclic aliphatic vinyl compounds include, without limitation, such compounds as styrene, α-methyl styrene, vinyl toluene, tert-butyl styrene, 2-vinyl pyrrolidone, 5-ethylidene-2-norbornene and 1-, 3-, and 4-vinylcyclohexene.

For completeness, whilst the above described co-polymerizable acid monomers should typically be used in the form of free acid, it is not precluded that the constituent acid groups of the monomers be partially or completely neutralized with suitable bases, provided this does not compromise their participation in co-polymerization.

The (meth)acrylate copolymer may be obtained by any known polymerization method, of which mention may be made of: solution polymerization in the presence of an organic solvent which can dissolve the obtained copolymer; suspension polymerization; bulk polymerization; emulsion polymerization; and, mini-emulsion polymerization. It is preferred herein to use solution polymerization from the standpoints of yield or productivity and the resultant performance of a coating film derived from the copolymer. In any of these methods, the polymerization temperature will usually be in the range from 30° C. to 120° C.: that temperature does not have to be held constant but may, for example, be raised during the polymerization.

The polymerization will conventionally be conducted using a free radical initiator, typically in an amount between 0.05 and 5 wt. % based on the total weight of monomers used. Suitable free radical initiators include: hydrogen peroxide; alkyl hydroperoxides, such as t-butylhydroperoxide and cumene hydroperoxide; persulphates, such as NH4-persulphate, K-persulphate and Na-persulphate; organic peroxides, such as acyl peroxides and including benzoyl peroxide; dialkyl peroxides, such as di-t-butyl peroxide; peroxy esters, such as t-butyl perbenzoate; and, azo-functional initiators, such as azo-bis(isobutyronitrile) (AIBN), 2,2′-azo-bis(2-methyl butane nitrile) (ANBN) and 4,4′-azobis(4-cyanovaleric acid).

The aforementioned peroxy initiator compounds may in some cases be advantageously used in combination with suitable reductors to form a redox system. As suitable reductors, there may be mentioned: sodium pyrosulphite; potassium pyrosulphite; sodium bisulphite; potassium bisulphate; acetone bisulfite; hydroxymethane sulfinic acid; and, isoascorbic acid. Metal compounds such as Fe.EDTA may also be usefully employed as part of the redox initiator system.

The person of skill in the art will be able to select an appropriate regimen for the addition of the initiator to the polymerization vessel in the course of the polymerization. It can be introduced both completely into the polymerization vessel, or used continuously or in stages according to its consumption in the course of the free radical polymerization. Preferably, a part is initially charged and the remainder supplied according to the consumption of the polymerization.

A chain transfer agent may also be present in the polymerization mixture, typically in an amount of from 0.01 to 1 wt. %, based on the total weight of monomers used. Exemplary chain transfer agents: mercaptans, such as n-dodecyl mercaptan; thioglycolic acid esters such as octyl thioglycolate; α-methylstyrene dimer; and, terpinolene.

The above polymerization methodologies aside, the at least one (meth)acrylate copolymer may equally be obtained from the marketplace. Suitable commercially available (meth)acrylate co-polymers for use in the present invention include but are not limited to: Loctite DURO-TAK 222A available from Henkel Corporation; DURO-TAK 87-202A available from Henkel Corporation; and, DURO-TAK 87-4287 available from Henkel Corporation.

### b) Non-Polymerizable Electrolyte

The composition comprises from 0.1 to 30 wt. %, based on the weight of the composition, of non-polymerizable electrolyte: said non-polymerizable electrolyte may preferably constitute from 1 to 20 wt. %, for example from 1 to 15 wt. % of the composition.

The non-polymerizable electrolyte preferably comprises at least one salt having a Formula selected from the group consisting of:

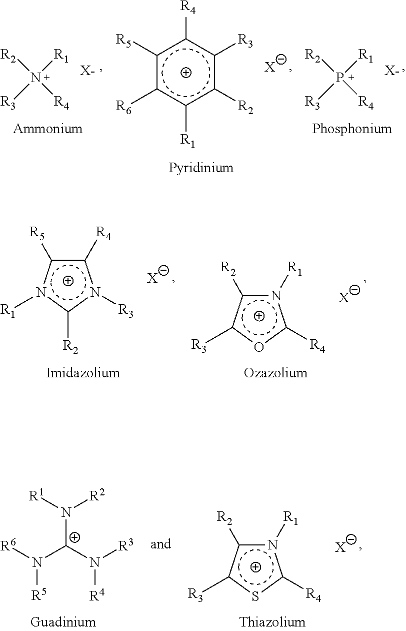

wherein: R¹, R², R³, R⁴, R⁵ and R⁶ are independently selected from hydrogen, C₁-C₁₈ alkyl, C₃-C₁₈ cycloalkyl, C₆-C₁₈ aryl, C₇-C₂₄ aralkyl, C₂-C₂₀ alkenyl, —C(O)R^{q}, —C(O)OH, —CN and —NO₂; and,
   R^{q} is C₁-C₆ alkyl.

Where an ammonium salt is used, it may be subject to the proviso that at most three and desirably at most two of the groups R1 to R4 may be hydrogen.

For completeness, the terms C1-C18 alkyl, C3-C18 cycloalkyl, C6-C18 aryl, C7-C24 aralkyl, C2-C20 alkenyl expressly includes groups wherein one or more hydrogen atoms are substituted by halogen atoms (e.g. C1-C18 haloalkyl) or hydroxyl groups (e.g. C1-C18 hydroxyalkyl). In particular, it is preferred that R1, R2, R3, R4, R5 and R6 are independently selected from hydrogen, C1-C12 alkyl, C1-C12 haloalkyl, C1-C12 hydroxyalkyl and C3-C12 cycloalkyl. For example, R1, R2, R3, R4, R5 and R6 may be independently selected from hydrogen, C1-C6 alkyl, C1-C6 haloalkyl and C1-C6 hydroxyalkyl.

There is no particular intention to limit the counter anion (X-) which may be employed in the non-polymerizable electrolyte. Exemplary anions may be selected from:
Halides;
Pseudohalides and halogen-containing compounds of the formulae PF₆⁻, CF₃SO₃⁻, (CF₃SO₃)₂N⁻, CF₃CO₂⁻ and CCl³CO₂⁻,
CN⁻, SCN⁻ and OCN⁻;
Phenates;
Sulfates, sulfites and sulfonates of the general formulae SO₄²⁻, HSO₄⁻, SO₃²⁻, HSO₃⁻, R^{a}OSO₃⁻ and R^{a}SO₃⁻;
Phosphates of the general formulae PO₄³⁻, HPO₄²⁻, H₂PO₄⁻, R^{a}PO₄²⁻, HR^{a}PO₄⁻ and R^{a}R^{b}PO₄⁻;
Phosphonates and phosphinates of the general formulae R^{a}HPO₃⁻, R^{a}R^{b}PO₂⁻ and R^{a}R^{b}PO₃⁻;
Phosphites of the general formulae: PO₃³⁻, HPO₃²⁻, H₂PO₃⁻, R^{a}PO₃²⁻, R^{a}HPO₃⁻ and R^{a}R^{b}PO₃⁻;
Phosphonites and phosphinites of the general formulae R^{a}R^{b}PO₂⁻, R^{a}HPO₂⁻, R^{a}R^{b}PO⁻ and R^{a}HPO⁻;
Carboxylic acid anions of the general formula R^{a}COO⁻;
Hydroxycarboxylic acids anions and sugar acid anions;
Saccharinates (salts of o-benzoic acid sulfimide);
Borates of the general formulae BO₃³⁻, HBO₃²⁻, R^{a}R^{b}BO₃⁻, R^{a}HBO₃⁻, R^{a}BO₃²⁻, B(OR^{a})(OR^{b})(OR^{c}(OR^{d})⁻, B(HSO₄)⁻ and B(R^{a}SO₄)⁻;
Boronates of the general formulae R^{a}BO₂²⁻ and R^{a}R^{b}BO⁻;
Carbonates and carbonic acid esters of the general formulae HCO₃⁻, CO₃²⁻ and R^{a}CO₃⁻;
Silicates and silicic acid esters of the general formulae SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻ and HR^{a}R^{b}SiO₄⁻;
Alkyl- and arylsilanolates of the general formulae R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻ and R^{a}R^{b}SiO₃²⁻;
Pyridinates and pyrimidinates;
Carboxylic acid imides, bis(sulfonyl)imides and sulfonylimides of the general formulae:

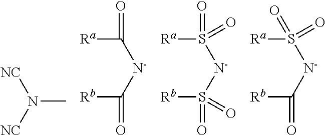

Methides of the general formula:

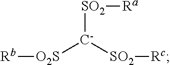

Alkoxides and aryloxides of the general formula R^{a}O⁻; and,
Sulfides, hydrogen sulfides, polysulfides, hydrogen polysulfides and thiolates of the general formulae S²⁻, HS⁻, [Sᵥ]²⁻, [HSᵥ]⁻ and [R^{a}S]⁻
   in which general formulae
v is a whole positive number of from 2 to 10.
R^{a}, R^{b}, R^{c} and R^{d} are independently selected from hydrogen, a C₁-C₁₂ alkyl, C₅-C₁₂ cycloalkyl, C₅-C₁₂ heterocycloalkyl, C₆-C₁₈ aryl and C₅-C₁₈ heteroaryl.

Based on the definitions in the above list, preferred anions are selected from the group consisting of: halides; pseudohalides and halogen-containing compounds as defined above; thiocyanates; carboxylic acid anions, in particular formate, acetate, propionate, butyrate and octanoate; hydroxycarboxylic acid anions, such as lactate; pyridinates and pyrimidinates; carboxylic acid imides, bis(sulfonyl)imides and sulfonylimides; sulfates, in particular methyl sulfate and ethyl sulfate; sulfites; sulfonates, in particular methanesulfonate; tetrafluoroborate; and, phosphates, in particular dimethyl-phosphate, diethyl-phosphate and di-(2-ethylhexyl)-phosphate.

The non-polymerizable electrolyte of the composition is preferably selected from the group consisting of 1-ethyl-3-methyl-1 H-imidazol-3-um methanesulfonate, 1-ethyl-3-methyl-1H-imidazol-3-um methyl sulfate, 1-hexyl-3-methylimidazolium 2-(2-fluoroanilino)-pyridinate, 1-hexyl-3-methylimidazolium imide, 1-butyl-1-methyl-pyrrolidinium 2-(2-fluoroanilino)-pyridinate, 1-butyl-1-methyl-pyrrolidinium imide, trihexyl (tetradecyl) phospholium 2-(2-fluoroanilino)-pyridinate, cyclohexyltrimethylammonium bis (trifluormethylsulfonyl) imide, di(2-hydroxyethyl) ammonium trifluoroacetate, N,N-dimethyl (2-hydroxyethyl) ammonium octanoate, methyltrioctylammonium bis (trifluoromethylsulfonyl) imide, N-ethyl-N-N-N-N-tetramethylguanidinium trifluoromethanesulfonate, guanidinium trifluoromethanesulfonate, 1-butyl-4-methylpyridinium bromide, 1-butyl-3-methylpyridinium tetrafluoroborate, 1-butyl-3-hydroxymethylpyridinium ethylsulfate, 1-butyl-1-methylpyrrolidinium bis (trifluoromethylsulfonyl) imide, 1-butyl-methylpyrrolidinium tris (pentafluoroethyl) trifluorophosphate, 1-ethyl-3-methylimidazolium ethylsulfate, 1-ethyl-3-methylimidazolium chloride, 1-ethyl-3-ethyl-methylimidazolium bromide, 1-butyl-3-methylimidazolium chloride, 1-hexyl-3-methylimidazolium chloride, 1-octyl-3-methylimidazolium chloride, 1-methyl-3-octylimidazolium chloride, 1-propyl-3-methylimidazolium iodide, 1-butyl-3-methylimidazolium tetrafluoroborate, 1-butyl-3-methylimidazolium trifluoromethanesulfonate, 1-ethyl-3-methylimidazolium hexafluorophosphate, 1-butyl-3-methylimidazolium hexafluorophosphate, 1-ethyl-3-methylimidazolium trifluoromethanesulfonate, 1-butyl-2,3-dimethylimidazolium tetrafluoroborate, 1-butyl-2,3-dimethylimidazolium hexafluorophosphate, 1-methylimidazolium tetrafluoroborate, 1-ethyl-3-methylimidazolium tetrafluoroborate, tetrabutylphosphonium tetrafluoroborate, tris (pentafluoroethyl) trifluorophosphate, trihexyl (tetradecyl) phosphonium tetrafluoroborate, 1-ethyl-3-methylimidazolium thiocyanate and mixtures thereof. A particular preference for the use of at least one of 1-ethyl-3-methylimidazolium chloride, 1-ethyl-3-methyl-1H-imidazol-3-um methanesulfonate, 1-ethyl-3-methylimidazolium trifluoromethanesulfonate, 1-ethyl-3-methyl-1H-imidazol-3-um methyl sulfate, 1-ethyl-3-methylimidazolium tetrafluoroborate and 1-ethyl-3-methylimidazolium thiocyanate may be mentioned.

### c) Solvent

To moderate its viscosity, the composition of the present invention comprises from 10 to 90 wt. % of solvent, based on the weight of the composition. More particularly, the composition comprises from 20 to 80 wt. %, for example from 30 to 70 wt. % of solvent, based on the weight of the composition.

Without intention to limit the present invention, the solvent may comprise one or more of: water; C1-8 alkanols such as methanol, ethanol, n-propanol, isopropanol, n-butanol, sec-butanol, tert-butanol, n-pentanol, n-hexanol and n-octanol; cyclopentanol; cyclohexanol; aromatic alcohols such as benzyl alcohol, phenyl ethanol, phenoxy ethanol, phenoxy propanol and phenoxy butanol; diols, particularly diols having from 2 to 12 carbon atoms such as ethylene glycol, propylene glycol, butylene glycol, 1,5-pentanediol, pentylene glycol, hexylene glycol and thiodiglycol; triols such as 1,2,6-hexanetriol; ketones and ketone-alcohols, such as acetone, methyl ethyl ketone, 2-pentanone, 3-pentanone, methyl isobutyl ketone, cyclohexanone and diacetone alcohol; tetrahydrofuran; dioxane; mono-C1-C4-alkyl ethers of diols having from 2 to 12 carbon atoms, such as ethylene glycol mono-(C1-C4)-alkyl ethers, propylene glycol mono-(C1-C4)alkyl ethers and in particular ethylene glycol monomethyl ether, ethylene glycol monobutyl ether, propylene glycol monomethyl ether, propylene glycol monopropyl ether, propylene glycol monobutyl ether; diethylene glycol mono-(C1-C4)alkyl ethers, such as diethylene glycol monomethyl ether and diethylene monobutyl ether; dipropylene glycol mono-(C1-C4)alkyl ethers, such as dipropylene glycol N-propyl ether, dipropylene glycol monopropyl ether and dipropylene glycol monobutyl; propylene glycol phenyl ether; C5-C14 ethers such as anisole and phenetole; linear amides, such as N,N-dimethylformamide and N.N-dimethylacetamide; cyclic amides such as 2-pyrrolidone, N-methyl-2-pyrrolidone, N-ethyl-2-pyrrolidone, caprolactam and 1,3-dimethylimidazolidone; sugar esters such as dimethyl isosorbide; cyclic esters such as caprolactone; sulfoxides, such as dimethyl sulfoxide and sulfolane; aliphatic and cycloaliphatic hydrocarbons, such as butane, pentane, hexane, cyclohexane and heptane; aromatic hydrocarbons, such as toluene, xylene, naphthalene, tetrahydronaphthalene and methyl naphthalene; chlorinated aromatic hydrocarbons, such as chlorobenzene, fluorobenzene, chloronaphthalene and bromonaphthalene; esters, such as butyl acetate, ethyl acetate, butoxyethyl acetate, methyl benzoate, ethyl benzoate, benzyl benzoate, butyl benzoate, phenylethyl acetate, butyl lactate, benzyl lactate, diethyleneglycol dipropionate, dimethyl phthalate, diethyl phthalate, dibutyl phthalate, di(2-ethylhexyl) phthalate; organic carbonate solvents, such as propylene carbonate, ethylene carbonate, dimethyl carbonate, ethyl methyl carbonate and diethyl carbonate.

In an embodiment, the solvent comprises or consists of at least one compound selected from the group consisting of: diols having from 2 to 8 carbon atoms; and, esters having from 3 to 8 carbon atoms. Preferred such diols include ethylene glycol, propylene glycol and butylene glycol. Preferred such esters include ethyl acetate and butyl acetate.

### d) Solubilizer

The compositions of the present invention may optionally comprise a solubilizer. The compositions may, for instance, contain from 0 to 10 wt. % or from 0 to 5 wt. % of solubilizer, based on the weight of the composition. The solubilizer has the functions of promoting the miscibility of the electrolyte b) within the adhesive composition and facilitating ion transfer therein. The solubilizer is, as such, preferably a polar compound and should desirably be liquid at room temperature.

Suitable classes of solubilizer include: polyphosphazenes; polymethylenesulfides; polyoxyalkylene glycols; polyethylene imines; silicone surfactants, such as polyalkylsiloxane and polyoxyalkylene modified polydimethylsiloxanes including but not limited to poly(C2-C3)oxyalkylene modified polydimethylsiloxanes; co-polymers of functionalized polyalkysiloxanes and epoxy resins, such as copolymers of polydimethylsiloxane (PDMS) and epoxy resin; polyhydric alcohols; and, sugars. For completeness, fluorinated silicone surfactants, such as fluorinated polysilanes, are intended to be encompassed within the term silicone surfactants.

Polyhydric alcohols and sugars such as ethylene glycol, 1,3-propanediol, cyclohexandiol, hydroquinone, catechol, resorcinol, phloroglucinol, pyrogallol, hydroxyhydroquinone, tris(hydroxymethyl)benzene, tris(hydroxymethyl)benzene with three methyl or ethyl substituents bonded to the remaining benzene carbon atoms, isosorbide, isomannide, isoidide, glycerol, cyclohexane-1,2,4-triol, 1,3,5-cyclohexanetriol, pentane-1,2,3-triol, hexane-1,3,5-triol, erythritol, 1,2,4,5-tetrahydroxybenzene, threitol, arabitol, xylitol, ribitol, mannitol, sorbitol, inositol, fructose, glucose, mannose, lactose, 1,1,1-tris(hydroxymethyl)propane, 1,1,1-tris(hydroxymethyl)ethane, di(trimethylolpropane), trimethylolpropane ethoxylate, 2-hydroxymethyl-1,3-propanediol, pentaerythritol allyl ether and pentaerythritol.

Of the polyoxyalkylene glycols, a particular preference for the use of polyoxy(C2-C3)alkylene glycols having an average molecular weight (Mw) of from 200 to 10000 g/mol, for example 200 to 2000 g/mol, may be noted. For completeness, the term polyoxy(C2-C3)alkylene refers to polyether radicals derived from ethyleneoxide, propyleneoxide or both ethyleneoxide and propyleneoxide.

### Adjunct and Additive Ingredients of the Composition

The solvent-borne pressure sensitive adhesive compositions of the present invention may, of course, also contain standard additives such as: tackifiers; polar rubbers; pigments; fillers; stabilizers; plasticizers; levelling agents; foam suppressing agents; and, rheology control agents. The choice of appropriate additives is limited only in that these must be compatible with the other components of the composition and cannot be deleterious to the use of the composition.

The solvent-borne pressure sensitive adhesive compositions of the present invention may comprise from 0 to 15 wt. %, based on the weight of the composition of at least one tackifying resin. Conventionally, the tackifier will be present in an amount up to 10 wt. %, based on the weight of the composition. The tackifying resin(s) should be characterized by: a softening point of from 70 to 150° C.; and, a viscosity at 150° C. of less than 2000 Pa·s.

Exemplary tackifying resins which may be used alone or in combination in the present invention include: aliphatic and cycloaliphatic petroleum hydrocarbon resins; aromatic petroleum hydrocarbon resins and the hydrogenated derivatives thereof; aliphatic/aromatic petroleum derived hydrocarbon resins and the hydrogenated derivatives; polycyclopentadiene resins, hydrogenated polycyclopentadiene resins and aromatic modified hydrogenated polycyclopentediene resins; terpenes, aromatic terpenes and hydrogenated terpenes; polyterpenes, aromatic modified polyterpenes and terpene phenolics; copolymers of α-methylstyrene and a further vinyl aromatic monomer; and, gum rosins, gum rosin esters, wood rosins, wood rosin esters, tall oil rosins, tall oil rosin esters and hydrogenated rosin esters.

Exemplary commercial tackifying resins having utility in the present invention include: Arkon™ P-70, P-90, P-100, P-125, P-115, M-90, M-100, M-110 and M-120 hydrogenated C5 and/or C9 hydrocarbon feed stocks available from Arakawa Chemical; Eastotac® H-100, H-115, H-130 and H-142R, available from Eastman Chemical Co.; Escorez® 5300, 5320, 5380, 5400, 5600 and 5637, available from Exxon Chemical Co.; WINGTACK® 95 and WINGTACK® Extra, available from Sartomer; and, Regalite R9001 and Regalite S5100, available from Eastman Chemical Company.

The present invention does not preclude the presence in the adhesive composition of at least one polar rubber: such rubbers are typically attained functionalization of apolar (co-)polymers with polar radicals such a nitrile, halogen, carboxyl, urethane or ester groups. Such functionalized rubbers include but are not limited to: nitrile rubber, such as Vamac® available from DuPont; epoxidized natural rubber; hydroxylated natural rubber; carboxylated natural rubber; epoxidized synthetic rubbers; hydroxylated synthetic rubbers; carboxylated synthetic rubbers; carboxylated nitrile rubber; carboxylated styrene butadiene rubber; hydroxylated styrene butadiene rubber; hydroxylated butadiene rubber; maleated styrene-isoprene-styrene block copolymers (SIS); maleated styrene-ethylene-butylene-styrene block copolymers (SEBS); (meth)acrylate modified SEBS copolymers; sulfonated SEBS copolymers; maleated styrene-ethylene-propylene-styrene block copolymer (SEPS); (meth)acrylate modified SEPS copolymers; and, sulfonated SEPS copolymers.

The composition of the present invention may comprise electrically non-conductive fillers. Broadly, there is no particular intention to limit the shape of the particles employed as non-conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as non-conductive fillers. However, such non-conductive fillers will conventionally have an average particle size (d50), as measured by laser diffraction, of from 0.1 to 1500 μm, for example from 1 to 1000 μm or from 1 to 500 μm.

Exemplary non-conductive fillers include but are not limited to calcium carbonate, calcium oxide, calcium hydroxide (lime powder), fused silica, amorphous silica, precipitated and/or pyrogenic silicic acid, zeolites, bentonites, wollastonite, magnesium carbonate, diatomite, barium sulfate, alumina, clay, talc, titanium oxide, iron oxide, zinc oxide, sand, quartz, flint, mica, glass beads, glass powder, and other ground mineral substances. Organic fillers can also be used, in particular wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added.

Also suitable as non-conductive fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less.

Non-conductive fillers which impart thixotropy to the composition may be preferred for many applications: such fillers are also described as rheological adjuvants, e.g. hydrogenated castor oil, fatty acid amides, or swellable plastics such as PVC.

It is also considered that the adhesive composition may comprise electrically conductive fillers. Again, there is no particular intention to limit the shape of the particles employed as conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as conductive fillers. However, such conductive fillers will conventionally have an average volume particle size, as measured by laser diffraction/scattering methods, of from 1 to 500 μm, for example from 1 to 200 μm.

Exemplary conductive fillers include, but are not limited to: silver; copper; gold; palladium; platinum; nickel; gold or silver-coated nickel; carbon black; carbon fiber; graphite; aluminum; indium tin oxide; silver coated copper; silver coated aluminum; metallic coated glass spheres; metallic coated filler; metallic coated polymers; silver coated fiber; silver coated spheres; antimony doped tin oxide; conductive nanospheres; nano silver; nano aluminum; nano copper; nano nickel; carbon nanotubes; and, mixtures thereof. The use of particulate silver and/or carbon black as the conductive filler is preferred.

The desired viscosity of the composition at its application temperature will be an important determinant of the total amount of filler—the sum of both conductive and non-conductive filler—which may be used. Having regard to that latter consideration, the total amount of fillers should not prevent the composition from being readily applicable by the elected method of application to the composition to a substrate. That aside, the composition of the present invention may conventionally comprise from 0 to 50 wt. %, for example from 0 to 30 wt. % based on the weight of the composition, of filler.

For completeness, it is preferred that the adhesive composition be characterized by a viscosity at 25° C. of less than 20000 mPa·s, for example from 1000 to 20000 mPa·s or from 1000 to 15000 mPa·s.

“Stabilizers” for purposes of this invention are to be understood as antioxidants, UV stabilizers, thermal stabilizers or hydrolysis stabilizers. When present, stabilizers may constitute in toto up to 5 wt. %, for instance from 0.1 to 2.5 wt. %, based on the total weight of the composition. Standard examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphite compounds; sulfur containing anti-oxidants, such as thioethers and thiodipropionate esters; and, mixtures thereof.

Sterically hindered phenols are well known to those skilled in the art and may be characterized as phenolic compounds which also contain sterically bulky radicals—such as tertiary butyl groups—in close proximity to the phenolic hydroxyl group thereof. The presence of these radicals in the vicinity of the hydroxyl group serves to retard its stretching frequency, and correspondingly, its reactivity. Representative sterically hindered phenols include: 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and, sorbitol hexa[3-(3,5-di-tert-butyl-4-hydroxy-phenyl)-propionate]. Exemplary commercial stabilizers which may be used alone or in combination include: SUMILIZER™ GM, SUMILIZER™ TPD and SUMILIZER™ TPS manufactured by Sumitomo Chemical Co., Ltd.; IRGANOX™ 656, IRGANOX™ 1010, IRGANOX™ HP2225FF, IRGAFOS™ 168, IRGANOX™ 1076, IRGANOX™ 1520, IRGANOX™ 1726, and TINUVIN™ P manufactured by Ciba Specialty Chemicals; JF77™ manufactured by Johoku Chemical Co., Ltd.; TOMINOX™ TT manufactured by API Corporation; Cyanox® LTDP, available from Cytec Industries; Ethanox® 330, available from Albemarle Corp; and, AO-412S™ manufactured by ADEKA CORPORATION.

In certain embodiments, plasticizers may be included to moderate the softness and flexibility of the solidified adhesive composition. One or more plasticizers may in this case be selected from the group consisting of: vegetable oil; mineral oil; soybean oil; aromatic esters such as dioctyl phthalate, diundecyl phthalate, tricresyl phosphate and triisononyl mellitate; linear esters such as di-tridecyl adipate; chlorinated Paraffin; aromatic and napthenic process oils; alkyl naphthalenes; and, low molecular weight polyisoprene, polybutadiene, or polybutylene resins. Conventionally, the amount of plasticizer should be from 0 to 20 wt. %, preferably from 0 to 10 wt. % or from 0 to 5 wt. % based on the total weight of the composition.

### Methods and Applications

The adhesive composition of the present invention may be formulated by bringing together the constituent ingredients in pre-determined amounts. In those embodiments where the ingredients are to be mixed, this may be performed using any of the mixing techniques known in the art: it would certainly be preferred however that the ingredients are not mixed by hand but are instead mixed by machine—a static or dynamic mixer, for example—in pre-determined amounts under anhydrous conditions.

As noted above, the present disclosure provides a bonded structure comprising: a first substrate having an electrically conductive surface; and, a second substrate having an electrically conductive surface, wherein the dried electrochemically debondable, pressure sensitive adhesive composition as defined hereinabove and in the appended claims is disposed between the electrically conductive surfaces of said first and second substrates.

To produce such a structure, the adhesive composition may be applied to at least one internal electrically conductive surface of the first and/or second substrates; the adhesive composition is dried to remove the solvent there from and to form a film on said surface(s); and, the two substrates are then subsequently contacted under the application of pressure, such that the electrically debondable adhesive composition is interposed between the electrically conductive surfaces of the first and second substrates.

In an alternative method of producing the bonded structure, the pressure-sensitive adhesive composition may be transferred to one or both of the electrically conductive surfaces of the substrates as a pre-formed film. In an exemplary method, the pressure-sensitive adhesive composition may be applied to a release liner; the adhesive composition is dried to remove the solvent therefrom and to form a film on said release liner; and, the film is covered with a second release liner and transposed to the internal electrically conductive surface. The two substrates are then subsequently contacted under the application of pressure, such that the film of electrically debondable adhesive is interposed between the electrically conductive surfaces of the first and second substrates.

Prior to applying the adhesive compositions to the first and second substrates, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as acetone, carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

In some embodiments, the adhesion of the compositions of the present invention to the preferably pre-treated substrates may be facilitated by the application of a primer thereto. Indeed primer compositions may be necessary to ensure efficacious fixture and/or drying times of the adhesive compositions on inactive substrates. Whilst the skilled artisan will be able to select an appropriate primer, instructive references for the choice of primer include but are not limited to: U.S. Pat. Nos. 3,855,040; 4,731,146; 4,990,281; 5,811,473; GB 2502554; and U.S. Pat. No. 6,852,193.

In lieu of applying a primer, it may be advantageous to pre-treat the application surface with a removable wetting agent prior to the step of applying the composition. The wetting agent should be compatible with the applied composition. Reference in regard to such pre-treatment may be made inter alia to: U.S. Pat. No. 4,389,363 (Molthop).

The person of ordinary skill in the art will be able to select the most appropriate method and loci for the application of the compositions of the present disclosure. Such application may be either through contact or non-contact means. Exemplary contact methodologies include brushing, roll coating and doctor-blade application. As exemplary non-contact methodologies, there may be mentioned printing, jetting, omega coating, control seam coating, slot spray coating, curtain spray coating and dot coating. The application of the composition under pressure is not required but should a pressurized application be elected, suitable pressures may from 2 to 60 bars, for example from 2 to 20 bars.

The above aside, central to any method of application is that the composition is sufficiently fluid upon application for it to flow over the desired surface application area. The adhesive should not however be so fluid that it does not readily set to form a fluid tight seal upon the surface application area. Useful application temperatures will typically range from 20° C. to 100° C. or from 20° C. to 80° C. with lower temperatures within this range being preferred as they may extend the working life of the composition. The temperature of the composition may be raised above its mixing temperature to the application temperature using conventional means: it may be expedient to use microwave induction for this purpose.

It is recommended that the compositions be applied to a surface at a wet film thickness of from 10 to 500 μm. The application of thinner layers within this range is more economical and provides for a reduced likelihood of deleterious thick dried regions. However, great control must be exercised in applying thinner coatings or layers so as to avoid the formation of discontinuous dried films.

The applied composition may then be subjected to an elevated temperature to remove the solvent therefrom, allowing the constituent copolymer(s) to come out of solution, to coalesce and form a continuous film on the substrate surface. Illustrative drying temperatures are from 50 to 200° C., for example from 50 to 150° C. This drying step may be performed using conventional means, such as an oven. Where applicable, the complete drying of the applied adhesive layer may be verified by experimentation, for instance through the attainment by the coated substrate of a constant mass.

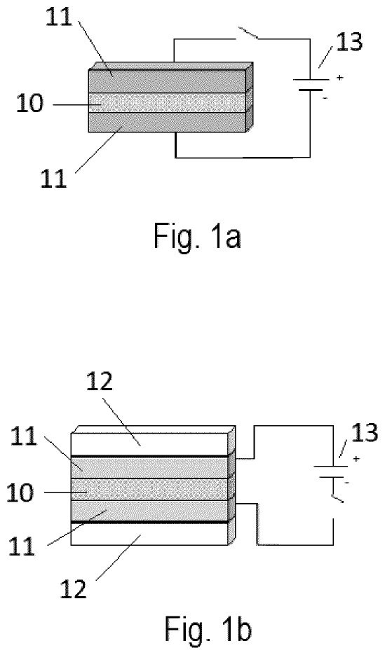

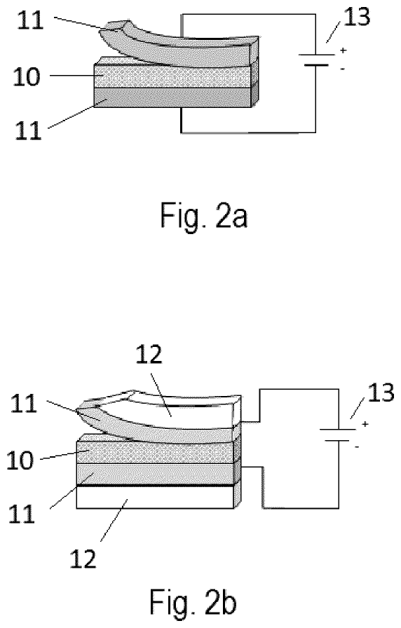

The present invention will be described with reference to the appended drawings in which:
FIG. 1a depicts a bonded structure in accordance with a first embodiment of the present invention.
FIG. 1b depicts a bonded structure in accordance with a second embodiment of the present invention.
FIG. 2a depicts an example of initial debonding of the structure of the first embodiment upon passage of a current across that structure.
FIG. 2b depicts an example of initial debonding of the structure of the second embodiment upon passage of a current across that structure.

As shown in FIG. 1a appended hereto, a bonded structure is provided in which a film of dried adhesive (10) is disposed between two conductive substrates (11). The conductive substrates (11) may be deposited or otherwise disposed upon a layer of non-conductive substrate (12) to form the more complex bonded structure as depicted in FIG. 1b. Each layer of conductive substrate (11) is in electrical contact with an electrical power source (13). The positive and negative terminals of that power source (13) are shown in one fixed position but the skilled artisan will of course recognize that the polarity of the system can be reversed.

For completeness, the power source of the Figures has been identified as a battery without intention to limit the present invention. It is envisaged that the conductive substrates of this disclosure may be in contact with any source of direct current, including AC-driven source of direct current (DC). In the alternative, the conductive substrates might be in contact with a source of alternating current (AC), such as an alternating current having a low frequency, for example of less than 60 Hz.

The two conductive substrates (11) are shown—for illustrative purposes only—in the form of a layer. The substrates may be the same or different and may, independently, be constituted by inter alia: a metallic film; a metallic mesh or grid; deposited metal particles; a conducting oxide; a plastic or resinous substrate which is rendered conductive by virtue of conductive elements disposed therein or thereon; a paper substrate, such as kraft paper, wood free paper, paperboard, glassine paper and parchment paper, which is rendered conductive by virtue of conductive elements disposed therein or thereon; and, a woven or non-woven fabric which is rendered conductive by virtue of conductive elements disposed therein or thereon. As exemplary conductive elements there may be mentioned conductive ink traces, copper filaments, silver filaments and carbon nano-particulates such as single-walled carbon nanotubes and multi-walled carbon nanotubes. As exemplary conducting oxides there may be mentioned: doped indium oxides, such as indium tin oxide (ITO); doped zinc oxide; antimony tin oxide; cadmium stannate; and, zinc stannate. The selection of the conductive substrate aside, the skilled artisan will recognize that the efficacy of the debonding operation may be diminished where the conductive substrates (11) are in the form of a grid or mesh which offers limited contact with the film of dried adhesive (10).

To facilitate the adhesion of the compositions of the present disclosure, the electrically conductive surfaces of the first and second substrates may be characterized by a surface energy of at least 50 dynes/cm, for example of at least 100 dynes/cm or of at least 250 dynes/cm, as measured according to the method of ASTM D2578. Whilst metals and alloys typically have a surface energy of at least 500 dynes/cm, resinous substrates and conductive oxides may not have such high surface energies and may need to be selected to meet this preferred characterization.

When an electrical voltage is applied between each conductive substrate (11), current is supplied to the adhesive film (10) disposed therebetween. This induces electrochemical reactions at the interface of the substrates (11) and the adhesive film, which electrochemical reactions are understood as oxidative at the positively charged or anodic interface and reductive at the negatively charged or cathodic interface. The reactions are considered to weaken the adhesive bond between the substrates allowing the easy removal of the debondable composition from the substrate.

As depicted in FIGS. 2a and 2b, the debonding occurs at the positive interface, that interface between the adhesive film (10) and the electrically conductive surface (11) that is in electrical contact with the positive electrode. By reversing current direction prior to separation of the substrates, the adhesive bond may be weakened at both substrate interfaces.

It is however noted that the composition of the adhesive film (10) may be moderated so that debonding occurs at either the positive or negative interface or simultaneously from both. For some embodiments, a voltage applied across both surfaces so as to form an anodic interface and a cathodic interface will cause debonding to occur simultaneously at both the anodic and cathodic adhesive/substrate interfaces. In an alternative embodiment, reversed polarity may be used to simultaneously disbond both substrate/adhesive interfaces if the composition does not respond at both interfaces to direct current. The current can be applied with any suitable waveform, provided that sufficient total time at each polarity is allowed for debonding to occur. Sinusoidal, rectangular and triangular waveforms might be appropriate in this regard and may be applied from a controlled voltage or a controlled current source.

Without intention to limit the present invention, it is considered that the debonding operation may be performed effectively where at least one and preferably both of the following conditions are instigated: a) an applied voltage of from 0.5 to 200 V, for example from 10 to 100 V; and, b) the voltage being applied for a duration of from 1 second to 120 minutes, for example from 1 second to 60 minutes. Where the release of the conductive substrate from the dried adhesive is to be facilitated by the application of a force—exerted via a weight or a spring, for instance—the potential might only need to be applied for the order of seconds.

The following examples are illustrative of the present invention and are not intended to limit the scope of the invention in any way.

### EXAMPLES

The following substrates were employed in the Examples:
LOCTITE DURO-TAK 222A: Solvent-based pressure sensitive adhesive based on (meth)acrylate copolymer resin (Solids Content: 41%).
1-ethyl-3-methylimidazolium trifluoromethanesulfonate: Available from TCI America Inc.
1-ethyl-3-methylimidazolium methanesulfonate: Available from TCI America Inc.
1-ethyl-3-methylimidazolium tetrafluoroborate: Available from TCI America Inc.
1-ethyl-3-methylimidazolium thiocyanate: Available from TCI America Inc.
1-ethyl-3-methylimidazolium chloride: Available from TCI America Inc.

Compositions were prepared in accordance with Table 1 herein below. The given ingredients were mixed in a speed mixer (1200 rpm; 1 minute) to ensure the formation of a homogenous mixture.

TABLE 1

| | Reference | | | | | |
|---|---|---|---|---|---|---|
| | Ex. 1 | Ex. 2 | Ex. 3 | Ex.4 | Ex. 5 | Ex. 6 |
| Ingredient | (wt. %) | (wt. %) | (wt. %) | (wt. %) | (wt. %) | (wt. %) |
| DURO-TAK222A | 100 | 95.6 | 95.6 | 95.6 | 95.6 | 95.6 |
| 1-ethyl-3-methylimidazolium | | 4.4 | | | | |
| trifluoromethanesulfonate | | | | | | |
| 1-ethyl-3-methylimidazolium methanesulfonate | | | 4.4 | | | |
| 1-ethyl-3-methylimidazolium tetrafluoroborate | | | | 4.4 | | |
| 1-ethyl-3-methylimidazolium thiocyanate | | | | | 4.4 | |
| 1-ethyl-3-methylimidazolium chloride | | | | | | 4.4 |

The test substrate was aluminium (AA6016), the surface of which had been cleaned with an ethyl acetate wipe. The substrate was provided at a thickness of 0.1 inch and cut into 2.5 cm×10 cm (1″×4″) samples for tensile testing. Tensile lap shear (TLS) test was performed at room temperature based upon ASTM D3163-01 Standard Test Method for Determining Strength of Adhesively Bonded Rigid Plastic Lap-Shear Joints in Shear by Tension Loading. The bond overlapping area for each stated substrate was 2.5 cm×2.5 cm (1″×1″) with a bond thickness of 0.1 cm (40 mil).

For each example, the pressure sensitive adhesive composition was coated onto the aluminum test substrates and dried in an oven at 120° C. to obtain an adhesive film. Two test substrates were then adhered to each other under the application of pressure and in accordance with the aforementioned bond area. The bonded structures were then stored at 25° C., 20% relative humidity for 24 hours prior to initial tensile testing.

For each bonded substrate, tensile lap shear strength was investigated after said 24 hour storage period both prior and subsequent to the application of a constant potential of 30V across the adhesive film for a duration of 30 minutes. The averaged results are documented in Table 2 herein below.

TABLE 2

| | Initial Bond Strength | Bond Strength after |
|---|---|---|
| Example | (MPa) | 30 V, 30 minutes (MPa) |
| R1 | 0.41 | 0.35 |
| 2 | 0.33 | 0.01 |
| 3 | 0.42 | 0.01 |
| 4 | 0.56 | 0.01 |
| 5 | 0.50 | 0.02 |
| 6 | 0.53 | 0.00 |

These results clearly demonstrate that bonded structures in accordance with the present invention can be effectively debonded by the application of a potential across the adhesive film. A comparable weakening of the adhesive bond between substrate layers is not observed in the comparative example wherein the pressure sensitive adhesive composition did not contain a non-polymerizable electrolyte.

In view of the foregoing description and example, it will be apparent to those skilled in the art that equivalent modifications thereof can be made without departing from the scope of the claims.

1: A bonded structure comprising:
a first substrate having an electrically conductive surface; and,
a second substrate having an electrically conductive surface;
wherein an electrochemically-debondable, pressure sensitive adhesive film is disposed between the electrically conductive surfaces of the first and second substrates, said adhesive film being obtained by drying of a solvent-borne composition comprising, based on the weight of the composition:
from 5 to 80 wt. % of a) at least one (meth)acrylate copolymer;
from 0.1 to 30 wt. % of b) non-polymerizable electrolyte; and,
from 10 to 90 wt. % of c) solvent.

2: The bonded structure according to claim 1, wherein said solvent-borne composition comprises, based on the weight of the composition:
from 15 to 75 wt. %, preferably from 30 to 70 wt. % of a) said at least one (meth)acrylate copolymer;
from 1 to 20 wt. %, preferably from 1 to 15 wt. % of b) said non-polymerizable electrolyte;
from 20 to 80 wt. %, preferably from 30 to 70 wt. % of c) solvent; and,
from 0 to 10 wt. %, preferably from 0 to 5 wt. % of d) solubilizer.

3: The bonded structure according to claim 1, wherein a) said at least one (meth)acrylate copolymer is characterized by at least one of: a glass transition temperature (Tg) of from −30° C. to 60° C.; and, a weight average molecular weight of from 50000 to 500000 daltons.

4: The bonded structure according to claim 1, wherein said at least one (meth)acrylate copolymer comprises, based on the total weight of monomers:
from 35 to 95 wt. %, preferably from 50 to 90 wt. % and more preferably from 60 to 85 wt. % of a1) at least one (meth)acrylate monomer represented by Formula A1:
H₂C═CGCO₂R¹ (A1)
wherein: G is hydrogen, halogen or a C₁ alkyl group; and,
R¹ is selected from: C₁-C₃₀ alkyl; C₂-C₃₀ heteroalkyl; C₃-C₃₀ cycloalkyl; C₂-C₈ heterocycloalkyl; C₂-C₂₀ alkenyl; C₂-C₁₂ alkynyl; C₆-C₁₈ aryl; C₁-C₉ heteroaryl; C₇-C₁₈ alkaryl; and, C₇-C₁₈ aralkyl;
from 5 to 65 wt. %, preferably from 10 to 50 wt. % and more preferably from 15 to 40 wt. % of a2) at least one (meth)acrylate monomer represented by Formula A2:
H₂C═CQCO₂R₂ (A2)
wherein: Q may be hydrogen, halogen or a C₁ alkyl group; and,
R² is selected from: C₁-C₁₈ hydroxyalkyl; and, C₃-C₃₀ hydroxycycloalkyl.

5: The bonded structure according to claim 4, wherein said at least one (meth)acrylate copolymer comprises, based on the total weight of monomers:
from 35 to 95 wt. %, preferably from 50 to 90 wt. % and more preferably from 60 to 85 wt. % of al) at least one (meth)acrylate monomer represented by Formula A1:
H₂C═CGCO₂R¹ (A1)
wherein: G is hydrogen, halogen or a C₁ alkyl group; and,
R¹ is selected from C₁-C₁₂ alkyl and C₃-C₁₂ cycloalkyl;
from 5 to 65 wt. %, preferably from 10 to 50 wt. % and more preferably from 15 to 40 wt. % of a2) at least one (meth)acrylate monomer represented by Formula A2:
H₂C═CQCO₂R₂ (A2)
wherein: Q may be hydrogen, halogen or a C₁ alkyl group; and,
R² is selected from: C₁-C₈ hydroxyalkyl; and, C₃-C₁₂ hydroxycycloalkyl.

6: The bonded structure according to claim 4, wherein a2) said at least one (meth)acrylate monomer represented by Formula A2 is selected from the group consisting of: 2-hydroxyethyl (meth)acrylate (HEMA); 2-hydroxypropyl (meth)acrylate; 3-hydroxypropyl (meth)acrylate; 3-hydroxybutyl (meth)acrylate; 4-hydroxybutyl (meth)acrylate; cyclohexanedimethanol mono-(meth)acrylate; 1,4-bis(hydroxymethyl)cyclohexane mono-(meth)acrylate; 1,4-dihydrocyclohexane mono-(meth)acrylate; and, octahydro-4,7-methano-1H-indene-dimethanol mono-(meth)acrylate.

7: The bonded structure according to claim 1, wherein said non-polymerizable electrolyte is selected from the group consisting of 1-ethyl-3-methyl-1H-imidazol-3-um methanesulfonate, 1-ethyl-3-methyl-1H-imidazol-3-um methyl sulfate, 1-hexyl-3-methylimidazolium 2-(2-fluoroanilino)-pyridinate, 1-hexyl-3-methylimidazolium imide, 1-butyl-1-methyl-pyrrolidinium 2-(2-fluoroanilino)-pyridinate, 1-butyl-1-methyl-pyrrolidinium imide, trihexyl (tetradecyl) phospholium 2-(2-fluoroanilino)-pyridinate, cyclohexyltrimethylammonium bis (trifluoromethylsulfonyl) imide, di(2-hydroxyethyl) ammonium trifluoroacetate, N,N-dimethyl (2-hydroxyethyl) ammonium octanoate, methyltrioctylammonium bis (trifluoromethylsulfonyl) imide, N-ethyl-N-N-N-N-tetramethylguanidinium trifluoromethanesulfonate, guanidinium trifluoromethanesulfonate, 1-butyl-4-methylpyridinium bromide, 1-butyl-3-methylpyridinium tetrafluoroborate, 1-butyl-3-hydroxymethylpyridinium ethylsulfate, 1-butyl-1-methylpyrrolidinium bis (trifluoromethylsulfonyl) imide, 1-butyl-methylpyrrolidinium tris (pentafluoroethyl) trifluorophosphate, 1-ethyl-3-methyl imidazolium ethylsulfate, 1-ethyl-3-methylimidazolium chloride, 1-ethyl-3-ethyl-methylimidazolium bromide, 1-butyl-3-methylimidazolium chloride, 1-hexyl-3-methylimidazolium chloride, 1-octyl-3-methylimidazolium chloride, 1-methyl-3-octylimidazolium chloride, 1-propyl-3-methylimidazolium iodide, 1-butyl-3-methylimidazolium tetrafluoroborate, 1-ethyl-3-methylimidazolium trifluoromethanesulfonate, 1-butyl-3-methylimidazolium trifluoromethanesulfonate, 1-butyl-3-methylimidazolium hexafluorophosphate, 1-butyl-2,3-dimethylim idazolium tetrafluoroborate, 1-butyl-2,3-dimethylimidazolium hexafluorophosphate, 1-methylimidazolium tetrafluoroborate, 1-ethyl-3-methylimidazolium tetrafluoroborate, tetrabutylphosphonium tris (pentafluoroethyl) trifluorophosphate, trihexyl (tetradecyl) phosphonium tetrafluoroborate, 1-ethyl-3-methylimidazolium thiocyanate and mixtures thereof.

8: The bonded structure according to claim 7, wherein said electrolyte is selected from the group consisting of 1-ethyl-3-methylimidazolium chloride, 1-ethyl-3-methyl-1H-imidazol-3-um methanesulfonate, 1-ethyl-3-methylimidazolium trifluoromethanesulfonate, 1-ethyl-3-methyl-1H-imidazol-3-um methyl sulfate, 1-ethyl-3-methylimidazolium tetrafluoroborate, 1-ethyl-3-methylimidazolium thiocyanate and mixtures thereof.

9: The bonded structure according to claim 1, wherein said solvent comprises or consists of at least one compound selected from the group consisting of: diols having from 2 to 8 carbon atoms; and, esters having from 3 to 8 carbon atoms.

10: The bonded structure according to claim 1, wherein said solvent-borne composition comprises a solubilizer in an amount up to 10 wt. % based on the weight of the composition, wherein said solubilizer is selected from the group consisting of polyoxy(C₂-C₃)alkylene glycols having an average molecular weight (Mw) of from 200 to 10000 g/mol.

11: The bonded structure according to claim 1, wherein the first and second substrates are independently selected from the group consisting of: metallic films; metallic meshes or grids; deposited metal particles; conducting oxides; plastic or resinous substrates which are rendered conductive by virtue of conductive elements disposed therein; paper substrates which are rendered conductive by virtue of conductive elements disposed therein or thereon; and, woven or non-woven fabrics which are rendered conductive by virtue of conductive elements disposed therein or thereon.

12: The bonded structure according to claim 1, wherein the electrically conductive surfaces of the first and second substrates are characterized by a surface energy of at least 50 dynes/cm, preferably at least 100 dynes/cm, more preferably at least 250 dynes/cm, as measured according to the method of ASTM D2578.

13: A method of debonding said bonded structure as defined in claim 1, said method comprising the steps of:
1) applying a voltage across both surfaces to form an anodic interface and a cathodic interface; and
2) debonding the surfaces.

14: The method according to claim 13, wherein step i) of this method is preferably characterized by at least one of:
an applied voltage of from 0.5 to 200 V; and,
the voltage being applied for a duration of from 1 second to 60 minutes.

15: An electrochemically debondable pressure sensitive adhesive, said composition comprising, based on the weight of the composition:
from 5 to 80 wt. % of a) at least one (meth)acrylate copolymer;
from 0.1 to 30 wt. % of b) non-polymerizable electrolyte; and,
from 10 to 90 wt. % of c) solvent.
